(19) United States
(12) Patent Application Publication
(10) Pub. No.: US 2011/0189486 A1
(43) Pub. Date: Aug. 4, 2011

(54) GLASS LAMINATE STRUCTURES AND METHODS OF MAKING SAME

(76) Inventor: Jay Morell Wendell, JR., The Woodlands, TX (US)

(21) Appl. No.: 12/999,583

(22) PCT Filed: Jun. 16, 2009
(86) PCT No.: PCT/US2009/047509

§ 371 Date: Mar. 18, 2011

Related U.S. Application Data
(60) Provisional application No. 61/061,944, filed on Jun. 16, 2008.
(60) Provisional application No. 61/061,935, filed on Jun. 16, 2008.

(51) Int. Cl. B32B 27/00; B32B 17/06; B32B 27/40; B32B 17/10

(52) U.S. Cl. 428/412; 428/429; 428/425.5; 156/329; 156/99

(57) ABSTRACT

The present invention provides glass laminate structures and methods of making them, wherein the structures can comprise, in various combinations, a first glass, a first film, and an adhesion promoter. The glass laminate structures of the present invention can further comprise one or more thermoset layers, one or more covers, additional films, and additional glasses.

### RELATED APPLICATIONS

This Application is related to Provisional Patent Application No. 61/061,944, filed on Jun. 16, 2008, and Provisional Patent Application No. 61/061,935, filed on Jun. 16, 2008, the entirety of both of which are hereby incorporated into this application by reference.

### BACKGROUND

Impact resistant glasses find applications in many fields that pertain to safety and security. These glasses are generally resistant to peneration by objects, such as bullets, rocks, and the like. However, currently used impact resistant glasses may be bulky and thick, thereby making them impractical for many applications. Such glasses may also have limited transparency and limited impact resistance per cross-sectional area. In addition, the transparency of such glasses may diminish significantly after an impact due to extensive shattering. Therefore, there is currently an unmet need for impact resistant glasses that are transparent, lightweight, and have a higher impact resistance per cross-sectional area than conventionally-prepared glasses. There is also an unmet need for impact resistant glasses that substantially retain their transparency after an impact.

### SUMMARY OF THE INVENTION

In one aspect, the present invention pertains to novel glass-laminate structures. Such glass-laminate structures may comprise, in various combinations, a first glass, a first film and an adhesion promoter. Desirably, the adhesion promoter can comprise one or more silane-based compounds. More desirably, the adhesion promoter can be between the first film and the first glass. In other aspects, the glass laminate structures of the present invention may further comprise, in various combinations and arrangements, one or more thermoset layers, one or more covers, one or more additional films, and/or one or more additional glasses.

In another aspect, the present invention provides methods for making such glass-laminate structures. For instance, a method may entail the application of an adhesion promoter to a surface of a glass, followed by the placement of a film on that surface. Alternatively, a method may entail the application of an adhesive to a surface of a film, followed by the placement of that surface on a glass. Thereafter, a method may entail the placement of one or more thermoset layers, one or more covers, one or more additional films, and/or one or more additional glasses on a glass laminate structure in various combinations and arrangements.

Advantageously, glass-laminate structures of the present invention can be generally transparent, lightweight, and compact. Furthermore, such structures may have a higher impact resistance per cross-sectional area than conventionally-prepared structures.

### BRIEF DESCRIPTION OF THE DRAWINGS

The foregoing and other features and aspects of the present invention will be best understood with reference to the following detailed descriptions of specific embodiments of the invention, when read in conjunction with the accompanying drawings, wherein:

FIGS. 1A to 1F depict different embodiments of glass-laminate structures that fall within the scope of the present invention.

FIG. 2 is a depiction of a hardened glass that may be suitable for use with glass-laminate structures of the present invention.

FIG. 3A shows a perspective view of a covered container that may be suitable for hardening glass in accordance with various embodiments of the present invention.

FIG. 3B shows an un-covered and top view of the container in FIG. 3A, where two glasses are positioned horizontally on the top portion of the container.

FIG. 4 shows a cross-section scanning electron micrograph (SEM) image of a hardened glass treated with a glass hardening method of the present invention at atmospheric pressure. The method was repeated two times to form two layers.

FIG. 5 shows a cross-sectional SEM image of a hardened glass treated with a glass hardening method of the present invention under vacuum pressure. The method was repeated two times to form two layers.

FIG. 6 shows a glass laminate structure of the present invention after impact with a bullet. The picture indicates that the bullet failed to penetrate the glass laminate structure. In addition, the structure substantially retained its transparency.

### DETAILED DESCRIPTION OF THE INVENTION

The definitions and explanations that follow are meant and intended to be controlling in any future construction unless clearly and unambiguously modified in the following Detailed Description or when application of the meaning renders any construction meaningless or essentially meaningless. In cases where the construction of the term would render it meaningless or essentially meaningless, the definition should be taken from Webster's Dictionary, 3^{rd} Edition. Definitions and/or interpretations should not be incorporated from other patent applications, patents, or publications, related or not, unless specifically stated in this specification or if the incorporation is necessary for maintaining validity.

Other than in the operating examples, or where otherwise indicated, all numbers expressing quantities of components used herein are to be understood as modified in all instances by the term “about.”

As used herein, a glass or a glass substrate (as used interchangeably) generally refers to a solid and substantially transparent object that may comprise silica as its main component. Many glasses and glass substrates may also be substantially porous.

As used herein, hardened, treated or tempered glass (as used interchangeably) generally refers to glass that has been processed by thermal and/or chemical treatments for enhanced strength. Likewise, glass hardening generally refers to the thermal and/or chemical treatment of glass for enhanced strength.

As used herein, the ability of a composition to set with a glass generally refers to the ability of the composition to bond with one or more functional groups of a glass substrate (e.g., such as but not limited to, silicon). Such bonding may occur via covalent bonding, ionic bonding, and the like. Such bonding may also occur on and/or below the surface of the glass. Furthermore, such bonding may occur after a composition penetrates the glass through various pores that may be present on a glass substrate.

As used herein, a layer generally refers to a composition of the present invention that has set with the glass. Such setting may occur on and/or below the surface of the glass. Furthermore, layers in the present invention may or may not be uniform. For instance, layers may be embedded with a glass substrate and/or other layers. Such embedding may occur through various pores on a glass substrate or other layers.

The present invention pertains to glass-laminate structures and methods of making such structures. In one embodiment, glass laminate structures of the present invention may generally comprise, in various combinations, a first glass, a first film, and an adhesion promoter. Desirably, the adhesion promoter can comprise one or more silane-based compounds. More desirably, the adhesion promoter can be between the first film and the first glass. In various other embodiments, glass-laminate structures of the present invention may further comprise, in various combinations and arrangements, one or more thermoset layers, one or more covers, one or more additional films, and/or one or more glasses.

In a more specific example, the present invention provides a glass laminate structure that comprises a first glass; and an adhesion promoter, wherein the adhesion promoter comprises one or more silane-based compounds. The glass laminate structure may further comprise a first film, and the adhesion promoter may be between the first film and the glass. In addition, the first film may be a thermoplastic polyurethane film.

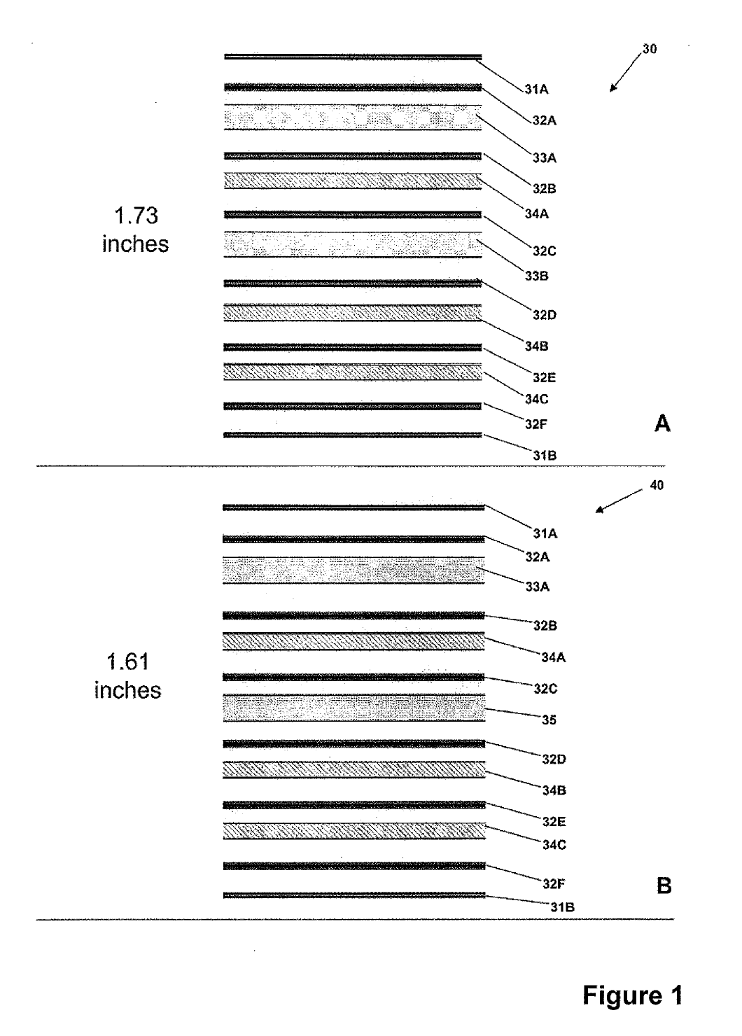

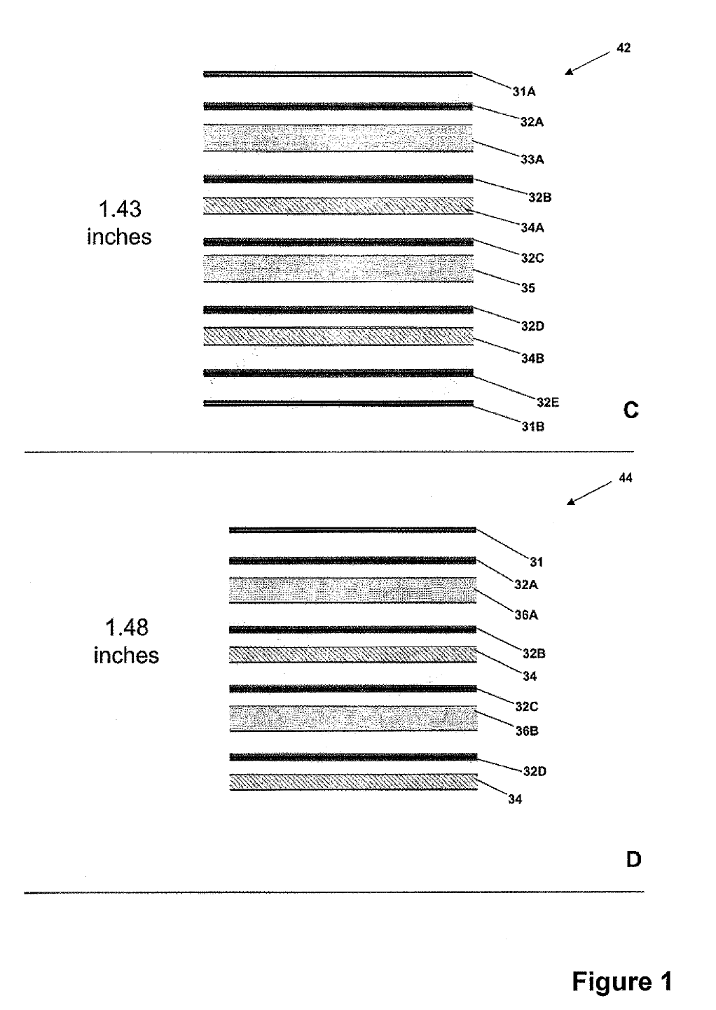

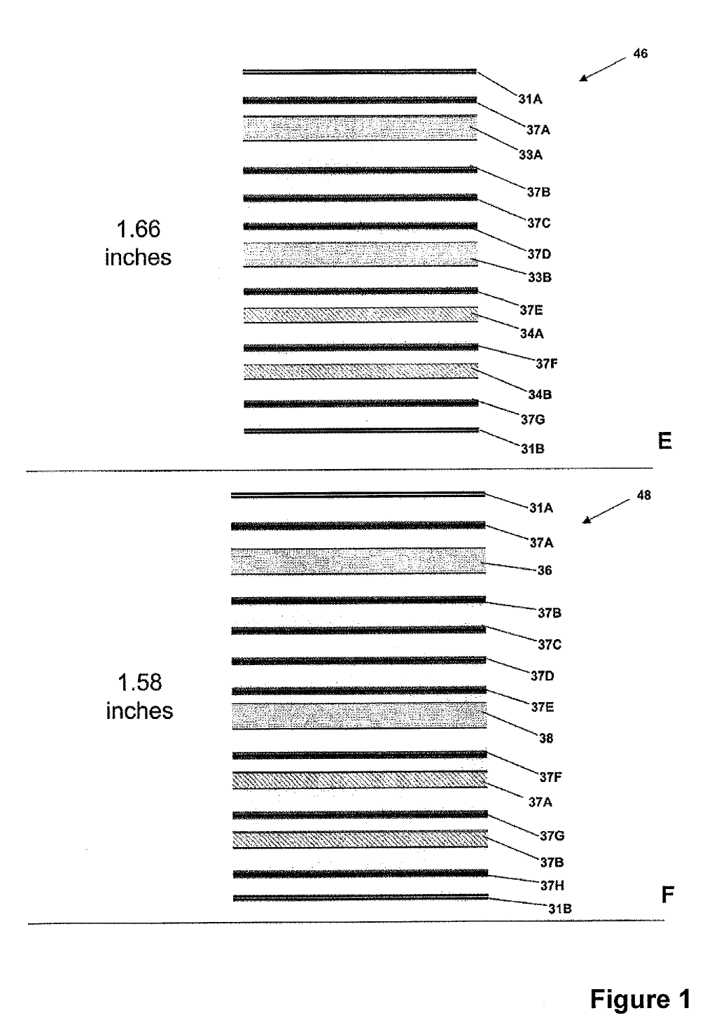

Referring now to FIG. 1A, glass laminate structure 30 is shown as one specific embodiment of the present invention. This specific embodiment comprises two polycarbonate covers 31 (31A and 31B), six Huntsman PE 450-01 thermoplastic polyurethane films 32 (32A to 32F), two ½ inch hardened glasses 33 (33A and 33B), and three thermoset layers 34 (34A to 34C), arranged as shown to form a glass laminate structure of about 1.73 inches in thickness.

Referring now to FIG. 1B, glass laminate structure 40 is shown as a variation of glass laminate structure 30, where the ½ inch hardened glass 33B was replaced with a ⅜ inch hardened glass 35 to form a glass laminate structure of about 1.61 inches in thickness. Likewise, FIG. 1C shows glass laminate structure 42 as a variation of glass laminate structure 40. In this specific embodiment, only two thermoset layers 34 (34A and 34B) and five films 32 (32A to 32E) were used, as opposed to three thermoset layers and six films in glass laminate structure 40, to form a glass laminate structure of about 1.43 inches in thickness.

FIG. 1D shows glass laminate structure 44 as another embodiment of the present invention. This specific embodiment comprises one polycarbonate cover 31, four Huntsman PE 450-01 thermoplastic polyurethane films 32 (32A to 32D), two ½ inch Starphire hardened glasses 36 (36A and 36B), and two thermoset layers 34 (34A and 34B) arranged as shown to form a glass laminate structure of about 1.48 inches in thickness.

FIG. 1E shows glass laminate structure 46 as another variation of glass laminate structure 30 shown in FIG. 1A. However, in this embodiment, seven Huntsman PE 418-17 thermoplastic polyurethane films 37 (37A to 37G) were used, as opposed to six Huntsman PE 450-01 films 32 in structure 30. In addition, in this embodiment, only two thermoset layers 34 (34A and 34B) were used, as opposed to three in structure 30. Furthermore, as shown in FIG. 1E, the components were arranged in a different manner to yield a glass laminate structure of about 1.66 inches in thickness.

Finally, FIG. 1F shows glass laminate structure 48 as a variation of glass laminate structure 4E, where ½ inch hardened glasses 33A and 33B were replaced with ½ inch Starphire hardened glass 36, and ⅜ inch Starphire hardened glass 38. An additional film 37h was also included, and the arrangement was slightly modified to yield a glass laminate structure of about 1.58 inches in thickness.

Applicants note that the glass laminate structures shown in FIG. 1 are included to demonstrate particular embodiments of the present invention. Therefore, the aforementioned structures do not limit the scope of the present invention in any way. Applicants will now describe the individual components of the glass-laminate structures of the present invention in more detail.

### Glass

Various glasses may be used in the glass laminate structures of the present invention. In one example, a glass may originate from a saphire glass. In other examples, glasses may originate from borosilicate glasses, aluminum oxynitrate glasses, Alon® glasses, Starphire® glasses, and the like. In more specific embodiments of the present invention, one or more glasses in the glass laminate structures of the present may be hardened for enhanced strength.

The glasses of the present invention may have various thickness ranges. In one example, the glasses may have a thickness range from about of about 0.5 inches to about 1.5 inches. In another example, the glasses may have a thickness range from about 0.5 inches to about 0.25 inches. In further examples, the glasses may have a thickness range from about 0.3 inches to about 0.5 inches.

### Hardened Glass

Hardened glasses in the present invention generally refer to glasses that have been processed by thermal and/or chemical treatments for enhanced strength. In one example, such treatment may entail the application of a coating composition to the glass, which may lead to the setting of one or more layers of the coating composition with the glass substrate. Such setting may occur on and/or below the surface of the glass. Furthermore, layers in the present invention may or may not be uniform. For instance, layers may be embedded with a glass substrate and/or other layers, possibly through various pores on a glass substrate or other layers.

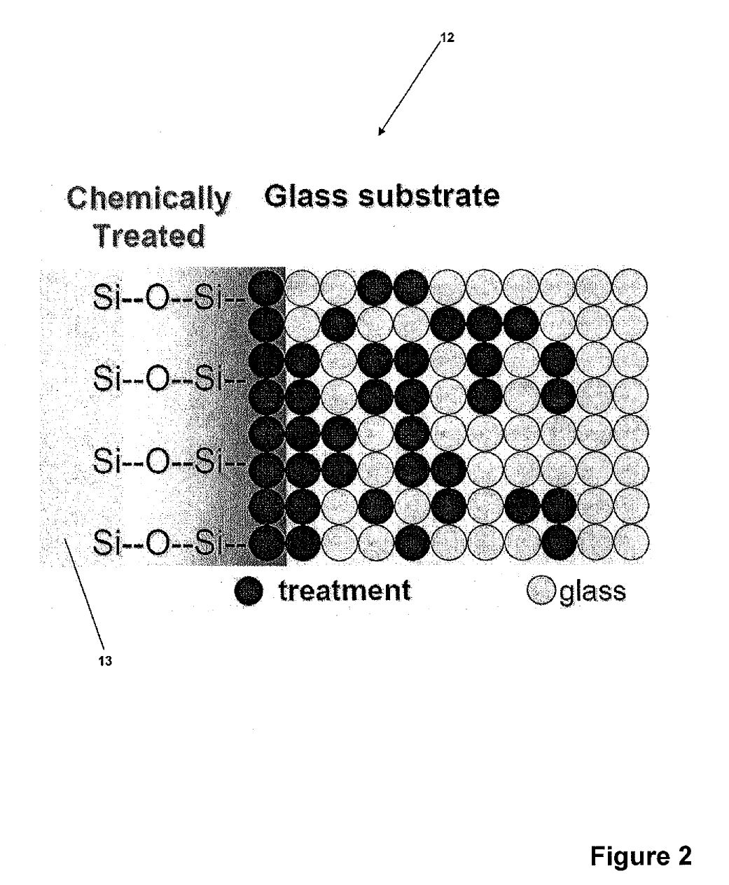

Referring now to FIG. 2, an example of a hardened glass suitable for use in the present invention is depicted, where glass 12 comprises layer 13 that has set on and below the surface of the glass after the treatment of the glass substrate with a coating composition. In particular, in this example, silicon functional groups of a coating composition in layer 13 are depicted to have bonded with the silicon groups of the glass substrate 12 on and below its surface.

### Coating Compositions

The coating compositions of the present invention generally refer to compositions that can form one or more layers with a glass substrate. In one example, a coating composition can generally comprise, in various combinations, one or more silane-based compounds, one or more glycols, one or more alcohols, and/or water. In various other embodiments, the coating compositions of the present invention may further comprise additional compounds.

### Silane-Based Compounds

Silane-based compounds in the coating compositions of the present invention generally refer to molecules with at least one silicon group. Many of the silane-based compounds suitable for the coating compositions of the present invention can generally be characterized by the structural formula below:

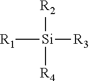

where any one of the R groups can be, without limitation, and in various combinations, a hydrogen group, an alkyl group, an alkoxy group, an amino group, an amino-alkyl group, a monovalent substituent group, another silane-based compound, and/or an isocyanate group. One or more of the R groups may also constitute various combinations of the aforementioned groups. However, the scope of the silane-based compounds of the present invention is not limited to the aforementioned structural formula and descriptions. Rather, the above formula and description are only exemplary.

More specific non-limiting examples of silane-based compounds suitable for coating compositions of the present invention can include amino-silane, alkoxy-silane, di-silane, alkyl-silane, methoxy-silane, methyltrimethoxysilane (MTMS), aminoethylaminopropylsilane, methoxy-terminated aminosilsesquioxanes, benzylaminoethylaminopropyltrimethoxysilane, aminoethylaminopropyltrimethoxysilane, dimethyldimethoxysilane, aminopropyl-triethoxysilane, vinyltrimethoxysilane, vinylbenzylaminoethylaminopropyltrimethoxy silane, methacryloxy propyltriethoxysilane, glycidoxypropyltrimethoxysilane, polydimethyl siloxane, octyltriethoxysilane, chloropropyltrimethoxysilane, glycidoxypropyltrimethoxysilane, glycidoxypropylmethyldiethoxysilane, phenyltrimethoxysilane, phenyltriethoxysilane, mercaptopropyltrimethoxysilane, bis-triethoxysilylpropyldisulfidosilane, vinyl tris(methoxyethoxy) silane, n-hexyltrimethoxysilane, n-octyltriethoxysilane, n-octyltrimethoxysilane, t-butyltrimethoxysilane, isobutyltriethoxysilane, and the like.

The coating compositions of the present invention may constitute one or more silane-based compounds in various concentrations. For instance, in one example, the silane-based compounds in a coating composition may constitute from about 60% by weight to about 100% by weight of the coating composition. In another example, the silane-based compounds of a coating composition may constitute from about 99% by weight to about 100% by weight of the coating composition. In a more specific example, a coating composition of the present invention may constitute from about 99.9% by weight to about 100% by weight of MTMS.

Without being bound by theory, silane-based compounds in coating compositions of the present invention can serve as adhesion promoters. For instance, as illustrated in FIG. 2, the silicon groups of the silane-based compounds may bond with the silicon groups of a glass substrate. The mechanism by which such bonding can occur is well known in the art. Furthermore, one can envision that such bonding may occur on the surface and/or below the surface of the glass. For instance, in one example, the silane-based compounds of the present invention may penetrate through pores that may be present on a glass surface. Thereafter, the silane-based compounds may form bonds with the silicon groups of the glass substrate below the surface of the glass. In another example, the silane-based compounds in the coating compositions of the present invention may remain on the surface of the glass and bond with the surface silicon groups of the glass substrate. In further embodiments, the silane-based compounds in the coating compositions of the present invention may bond with silicon groups that are on and below the surface of a glass substrate.

The silane-based compounds in the coating compositions of the present invention can provide various advantages. For instance, unlike conventional acrylics, silane-based compounds in the coating compositions of the present invention can be resistant to yellowing if repeatedly and extensively exposed to ultraviolet light. It is also envisioned that the silane-based compounds in the coating compositions of the present invention may imbue UV protection to glass substrates. In addition, since the silane-based compounds in the coating compositions of the present invention are generally smaller molecules than their acrylic-based counterparts, they may be able to penetrate deeper into the natural pores of glass, thereby producing greater glass laminate adhesion.

### Glycols

In the present invention, glycols generally refer to chemical compounds with at least two hydroxyl groups. Exemplary but non-limiting examples of glycols in the coating compositions of the present invention can include without limitation propylene glycol, ethylene glycol, polyethethylene glycol, silicon glycol, and the like.

The coating compositions of the present invention may constitute one or more glycols in various concentrations. For instance, in one example, the glycols in a coating composition may constitute from about 0.001% by weight to about 40% by weight of the composition. In another example, the glycols in a coating composition may constitute from about 0.01% by weight to about 1% by weight of the composition. In a more specific example, a coating composition of the present invention may constitute from about 0.001% by weight to about 0.1% by weight of propylene glycol. In other examples, however, glycols may be entirely absent from a coating composition of the present invention.

Without being bound by theory, glycols in the coating compositions of the present invention can serve as surface tension breakers that enhance the strength properties of the treated glasses. This can occur because glycols may react with the silane-based compounds in the coating compositions of the present invention to form silicon glycol copolymers that have enhanced penetration properties into the glass pores. Such copolymers can also enhance the strength of any formed layers with the glass.

### Alcohols

In the present invention, alcohols generally refer to chemical compounds with at least one hydroxyl group bound to a carbon atom. Exemplary but non-limiting examples of alcohols in the present invention can include methanol, octanol, ethanol, propanol, iso-propanol, butanol, cyclohexanol, phenol, and the like. Without being bound by theory, alcohols in the coating compositions of the present invention can serve as carrier agents or solvents.

The coating compositions of the present invention may constitute one or more alcohols in various concentrations. For instance, in one example, the alcohols in the coating compositions of the present invention may constitute from about 0.01% by weight to about 25% by weight of the composition. In another example, the alcohols in the coating compositions of the present invention may constitute from about 0.01% by weight to about 1% by weight of the composition. In a more specific example, a coating composition of the present invention may constitute from about 0.001% by weight to about 0.1% by weight octyl alcohol. In further embodiments, the coating compositions of the present invention may not contain any alcohols.

### Water

In the present invention, water generally refers to a molecule with the molecular formula of H₂O. As used in the present invention, water may be in pure form in some embodiments, such as in de-ionized form.

The coating compositions of the present invention may constitute various concentrations of water. For instance, in one example, water may constitute from about 0.01% by weight to about 50% by weight of the composition. In another example, water may constitute from about 0.01% by weight to about 25% by weight of a coating composition. In another example, water may constitute from about 0.001% by weight to about 0.1% by weight of a coating composition. In further embodiments, the coating compositions of the present invention may not contain any water.

The aforementioned components can form a broad array of coating compositions. In one example, a coating composition of the present invention may comprise about 100% by weight methyltrimethoxysilane (MTMS). In another example, a coating composition of the present invention may comprise about 99.9% by weight MTMS and about 0.01% by weight the combination of propylene glycol, water and octyl alcohol. In another example, a coating composition of the present invention may contain about 10% by weight methanol and about 90% by weight Z-6020 (Dow Corning chemical compound comprising ˜60% Aminoethylaminopropyltrimethoxysilane, ˜15-40% Methoxysilane, ˜1% methanol, and ˜1% ethylenediamine). In further embodiments, a coating composition of the present invention may contain about 50% by weight MTMS and about 50% by weight Z-6341 (Dow Corning chemical compound comprising ˜60% N-Octyltriethoxysilane, ˜2% branched oxtyltriethoxysilanes, and ˜1% ethanol)

### Films

In the present invention, a film generally refers a substantially transparent composition that can adhere to a glass surface (or another surface) for enhanced impact resistance and/or enhanced tensile strength. Without limitation, such films can comprise aliphatic polyether films, such as thermoplastic polyurethane films. Commercial examples of such films can include, without limitation, Hunstman thermoplastic polyurethane films PE-399, PE-501, PE-450-01, and PE-4,8-17.

In additional embodiments, films suitable for use in the present invention may be treated with and/or modified by silane-based compounds. In one example, such treatment may occur during the extrusion of a film. It is envisioned that such treatments may enhance the impact resistance of glass laminate structures by at least enhancing the tensile strength of the treated films within each structure.

The glass-laminate structures of the present invention may contain one or more films, and more desirably, from about 4 films to about 8 films in various arrangements with other components (e.g., as shown in FIG. 1).

### Adhesion Promoters

Adhesion promoters in the present invention generally refer to compounds or compositions that can facilitate the adhesion of various components of the present invention to one another. In one example, an adhesion promoter may be used to enhance the adhesion of a film to another film and/or to a glass substrate. In another example, an adhesion promoter may be used to enhance the adhesion of a glass substrate to another glass substrate.

Various adhesion promoters are suitable for use with the glass-laminate structures of the present invention. In one example, an adhesion promoter may comprise one or more silane-based compounds. In more specific examples, an adhesion promoter composition may also comprise alcohols, glycols, and/or other compounds. Adhesion promoter compositions of the present invention may further comprise a catalyst, such as titanate. In additional examples, adhesion promoter compositions may resemble the coating compositions of the present invention, as described previously.

A specific and non-limiting example of an adhesion promoter composition suitable for use in the present invention can include Z-6020 (Dow Corning chemical compound comprising ˜60% Aminoethylaminopropyltrimethoxysilane, ˜15-40% Methoxysilane, ˜1% methanol, and ˜1% ethylenediamine). In another example, Z-6020 may further comprise titanate, desirably from about 0.01% by weight to about 1% by weight of the composition. Other suitable adhesion promoter compositions can include, without limitation, Z-6040 (Dow Corning chemical compound comprising ˜60% Glycidoxypropyl trimethoxysilane) and Z-6042 (Dow Corning chemical compound comprising ˜60% Methyl (glycidoxypropyl) diethoxysilane). In other embodiments, such compositions may also comprise titanate, desirably from about 0.01% by weight to about 1% by weight of the compositions.

Adhesion promoters in the present invention may be present in various forms. For instance, in one example, adhesion promoters may be present on one side of a film. In another example, adhesion promoters may be in liquid form and capable of being applied to a film or a glass substrate by various methods.

Without being bound by theory, it is envisioned that adhesion promoters can enhance the strength and impact resistance of glass laminate structures of the present invention by facilitating the adhesion of various components within a structure to one another. It is envisioned that adhesion promoters can have such effects by forming chemical bonds with the functional groups of two or more components. For instance, if an adhesion promoter of the present invention comprises a silane-based compound, a silicon group in the compound may form a chemical bond with a silicon group associated with a glass. The silicon group in the compound may also form another chemical bond with the urethane linkage in a polyurethane thermoplastic film (if used).

### Thermoset Layers

Thermoset layers in the present invention generally refer to layers that can enhance the structural integrity and/or impact resistance of the glass laminate structures of the present invention. In one example, a thermoset layer may be a thermoset plastic, composed of one or more polymers, such as, without limitation, polyurethanes, polyesters, and/or polyimides. In more specific examples, thermoset layers in the present invention may be water clear aliphatic polymers, impact resistant aliphatic-based urethane polymers, and the like. In further examples, thermoset layers in the present invention may be co-polymers.

In additional examples, a thermoset layer may be a copolymer that comprises cyclobutanediol. More specifically, a thermoset layer may be a co-polyester derived from 2,2,4,4-tetramethyl-1,3-cyclobutanediol, 1,3-propanediol, and/or dimethyl terephthalate (DMT). In another example, a thermoset layer may be a co-polyterephthalate of 2,2,4,4-tetramethyl-1,3-cyclobutanediol, 1,3-propanediol, and/or dimethylterephthalate. Such co-polymers have been found to have enhanced impact resistant properties. E.g., Booth et. al., Copolyterephthalates containing tetramethylcyclobutane with impact and ballistic properties greater than bisphenol A polycarbonate. Polymer (2006), 47:6398-6405; Beall et. al., Physical properties of CBDO based co-polyterephthalate nanocomposites. Applied Clay Science (2006), 37 (3-4): 295-306.

In further embodiments, thermoset layers in the present invention may be treated and/or modified by silane-based compounds to possibly enhance their tensile strength and impact resistance. In one example, such treatment may occur during the extrusion of a thermoset layer.

The glass-laminate structures of the present invention may contain one or more thermoset layers, and more desirably from about 2 to about 3 thermoset layers in various arrangements with other components. However, in other embodiments, glass laminate structures may not contain any thermoset layers.

### Covers

In the present invention, covers generally refer to layers that can absorb and/or contain (in a substantial or non-substantial manner) an impact upon a glass laminate structure. Non-limiting examples of such structures include polyethylenes, polycarbonates, polymethylmethacrylates, polypropylenes, and the like. In further embodiments, covers in the present invention may be treated and/or modified by silane-based compounds to possibly enhance their impact resistance.

The glass-laminate structures of the present invention may contain one or more covers, and more desirably from about 1 to about 2 covers in various arrangements with the other components. However, in other embodiments, glass laminate structures may not contain any covers.

### Glass-Laminate Formation

Various methods can be used to form glass laminate structures in the present invention. In one specific and non-limiting example, the method may comprise applying an adhesion promoter to a surface of a glass and then placing a film on the applied surface of the glass. Alternatively, an adhesion promoter may be applied (or even be on) the surface of a film. In such embodiments, the film with the adhesion promoter may simply be placed on a glass. In further embodiments, an adhesion promoter may be applied to both surfaces of a film and a glass. Thereafter, additional films, covers, thermoset layers, and/or glasses may be mounted onto or below the structure in various arrangements. In further embodiments, glass laminate structures of the present invention may be formed by using one or more hardened glasses.

In another embodiment, a method of forming a glass laminate structure may comprise: a) providing a first glass; b) applying an adhesion promoter to a surface of the glass, wherein the adhesion promoter comprises one or more silane-based compounds; and c) placing a film on the surface of the glass. In another embodiment, a method of forming a glass laminate structure may comprise: a) providing a first glass; b) applying an adhesive to a surface of a film; and c) placing the film on a surface of the glass.

### Glass Hardening

Glass laminate structures of the present invention may include one or more hardened glasses. If desired, such hardened glasses can be manufactured by various methods. Such methods may generally comprise the application of a coating composition to a glass followed by an incubation period that is sufficient for setting to occur. In some embodiments, the glass to be hardened may optionally be rinsed and/or washed before such treatment. For instance, in one embodiment, the glass to be treated may be rinsed with acetone. In another embodiment, the glass may be washed with soap and/or water. Thereafter, the glass may be dried by various methods (e.g., heating in a heat enclave, such as a whirlpool oven).

A glass to be treated may also be placed in various positions. For instance, a glass may be positioned horizontally or vertically. The glass in other embodiments may also be positioned at a certain angle.

Once the glass is placed in a desired position, a coating composition may be applied to the glass by various mechanisms. For instance, a coating composition may be sprayed onto a surface of a glass in one embodiment. In another embodiment, a coating composition may be poured onto the glass such that the glass becomes immersed and/or submerged in the composition.

In other embodiments, one or more curing agents may also be used to facilitate the hardening of the glass. Such curing agents include without limitation, ultraviolet light, radiation (e.g., y radiation), heat, and catalysts (e.g., titanate). In addition, such curing agents may be applied to the coating compositions of the present invention before, during, or after treatment.

The glass to be treated may also be incubated under various conditions. For instance, in one embodiment, the incubation may occur at atmospheric pressure. In another embodiment, incubation may take place in the presence of a vacuum force. In a more specific embodiment, the incubation may take place in the presence of a vacuum force of about 27 torr to about 28 torr. However, other vacuum forces may also be suitable. Non-limiting examples of such suitable ranges include from about 20 torr to about 29 torr, or from about 23 torr to about 24 torr. However, various embodiments will function in any vacuum conditions.

In another embodiment, a glass to be treated may first be subject to a vacuum force. A composition of the present invention may then be applied to the glass that is under vacuum pressure, followed by an incubation period. In another embodiment, a composition of the present invention may first be applied to the glass. Thereafter, a vacuum force may be actuated followed by an incubation period.

In embodiments utilizing a vacuum, the vacuum may be applied by any mechanism common in the art. Various non-limiting examples include but are not limited to hypobaric chamber, suction hose, vacuum chamber, hand held vacuum system, vacuum hose, and/or the like. In general, any vacuum can be used.

Applicants have observed that the use of vacuum force during treatment can enhance the strength of the hardened glasses. Without being bound by theory, it is envisioned that such effects may be due to the enhanced penetration of the coating compositions of the present invention through glass pores under vacuum force.

The incubation period required for hardening glass can also vary depending on the conditions and coating compositions used, and whether one or more curing agents are employed. For instance, if incubation occurs at atmospheric pressure, then a suitable incubation period may be from about 12 hours to about 72 hours, and possibly for about 12 hours. However, if a vacuum force is used, then a suitable incubation period may be from about 3 hours to about 12 hours, and possibly for about 4 hours. In general, irrespective of the use of a vacuum, any curing time can be used. As such, in various embodiments, curing time is a separate process from a vacuum force process.

In various embodiments utilizing a vacuum, the vacuum time can be optimized. In an embodiment, a vacuum force is applied from between about 10 seconds and about 100 hours. In an alternate embodiment, a vacuum force is applied from between about 10 minutes and about 48 hours. In an alternate embodiment, a vacuum force is applied from between about 60 minutes and about 24 hours. In an alternate embodiment, a vacuum force is applied from between about 12 hours and about 12 hours. In an alternate embodiment, a vacuum force is applied from between about 4 hours and about 6 hours. In general, any vacuum time is acceptable and can be optimized to improve results.

After setting occurs, the aforementioned glass hardening steps may be repeated several times on a single glass substrate to form multiple layers. Applicants have observed that the formation of multiple layers can enhance the strength of the treated glasses. Without being bound by theory, it is envisioned that such effects may be due to the enhanced penetration of the coating compositions of the present invention through glass pores when a glass is treated multiple times. It is further envisioned that the layers in the coating compositions of the present invention may strengthen one another by inter-layer penetration.

Various equipment may be used to harden glass. In some embodiments, such equipment may include a container (either covered or uncovered), a tray, or other similar structures. A non-limiting example of an equipment may include a polyethylene-based open container. In other embodiments, however, treatment may simply occur on a surface without the use of any equipment.

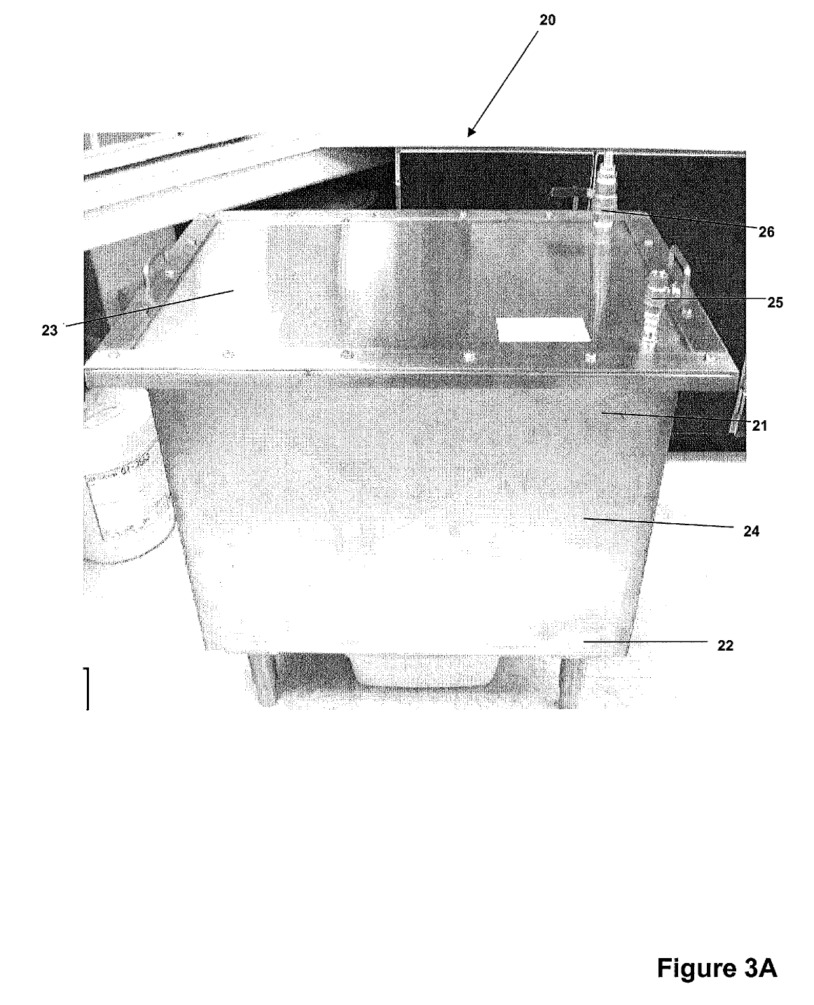

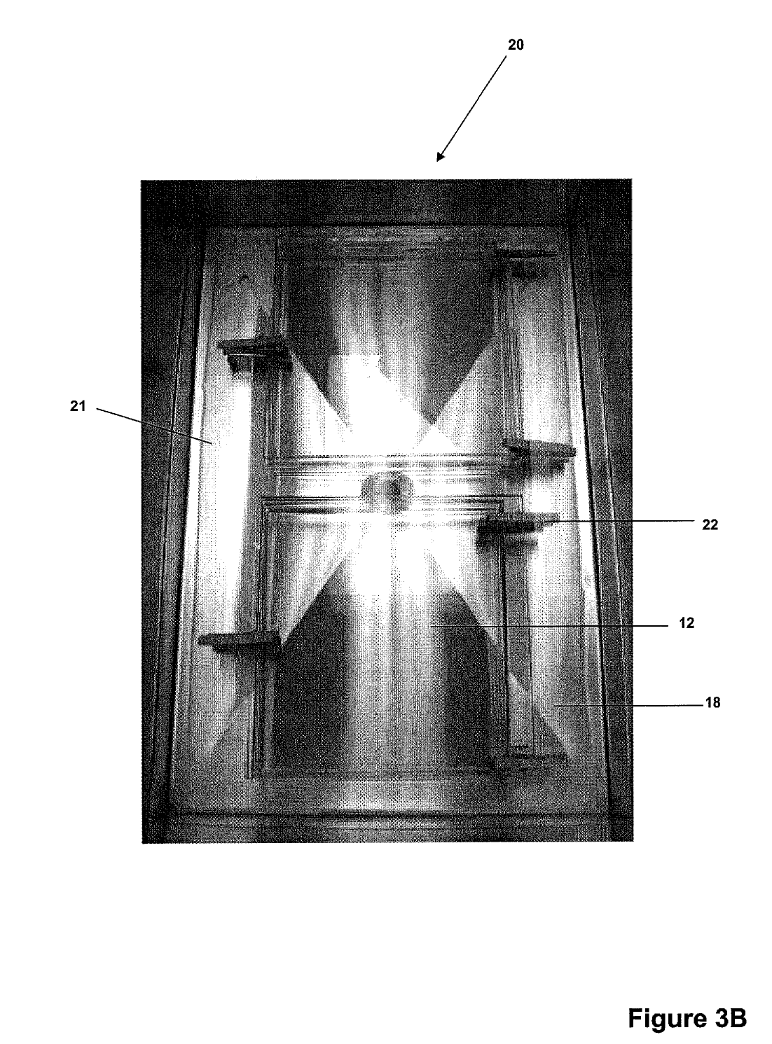

Referring now to FIG. 3A, container 20 is shown as one example of one equipment that can be used to harden glass. In this example, container 20 generally comprises top portion 21, bottom portion 22, removable cover 23, housing 24, vacuum outlet port 25, and inlet port 26. FIG. 3B shows a top view of container 20 with cover 23 removed. As shown, top portion 21 comprises edges 28 that can anchor glasses 12 in a horizontal position in the container. Glasses 12 may also be associated with pins 22 for additional support.

Once glasses 12 are positioned on top portion 21 of container 20, a coating composition may be applied to the glass. This can result in the immersion of the surface with the composition. The remaining coating composition may then flow into housing 24 for subsequent dispensing. Thereafter, cover 23 can be placed on top portion 21 if one desires incubation to occur in a closed environment.

In other embodiments, vacuum outlet port 25 may also be connected to a vacuum. The vacuum can then be actuated if one desires for an incubation to take place under a vacuum force. In further embodiments, the vacuum force may be actuated before the application of a coating composition to the glass. Thereafter, a coating composition may be applied to the glass through inlet port 26.

After the completion of the incubation period, the vacuum force may be disconnected, and cover 23 may be removed. Thereafter, the aforementioned steps may be repeated, especially if one desires additional layers to form on a glass.

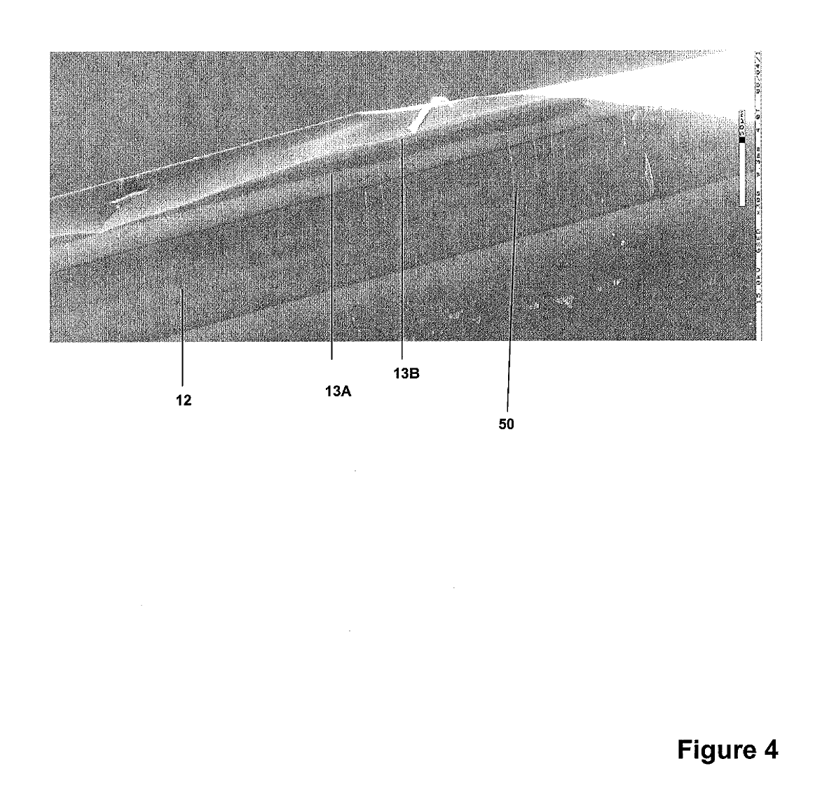

Referring now to FIG. 4, a Scanning Electron Micrograph (SEM) image of a cross-sectional area of a hardened glass is shown that was hardened with a hardening method of the present invention. In particular, the glass was incubated with a composition comprising about 99.9% by weight MTMS and about 0.01% by weight the combination of propylene glycol, water and octyl alcohol in a polyethylene container. After 12 hours of incubation at atmospheric pressure, the glasses were dried at ambient temperature for another 12 hours. Thereafter, the glasses were placed back in the container for an additional round of treatment.

The SEM image shown in FIG. 4 indicates that the hardened glasses 12 formed first layer 13A and second layer 13B with the glass. Furthermore, several cracks 50 appeared on the SEM image that spanned glass 12, first layer 13A and second layer 13B. Such cracks may indicate that the compositions of the present invention in both the first layer and the second layer penetrated below the surface of glass 12, possibly through various pores.

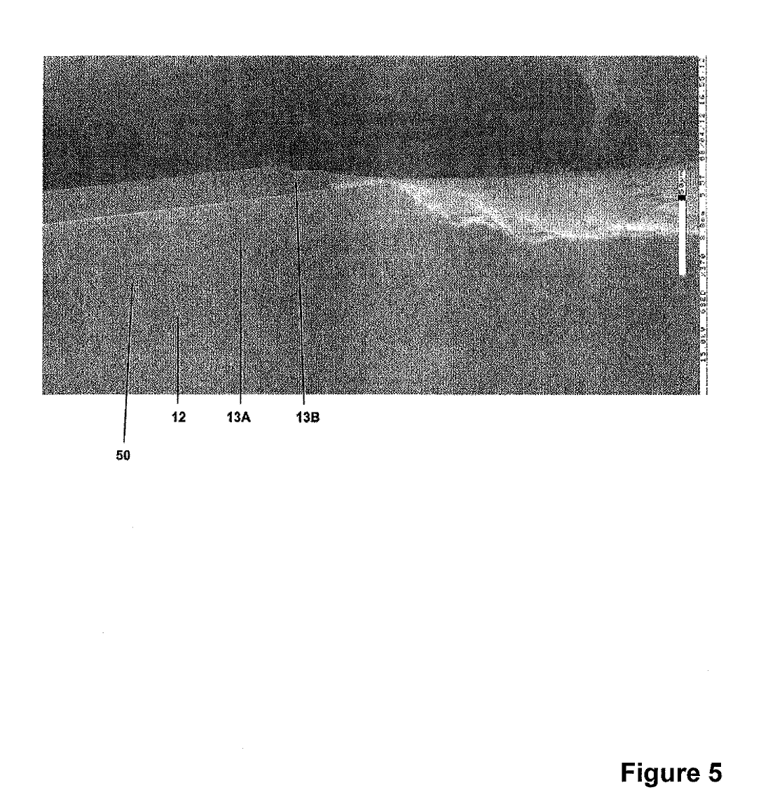

Referring now to FIG. 5, an SEM image of a cross-sectional area of another hardened glass is shown that was hardened with another hardening method of the present invention. In particular, glasses were placed in container 20 as previously described and shown in FIGS. 3A and 3B. Cover 23 was then placed on the glass as shown in FIG. 3B. Thereafter, vacuum outlet port 25 on cover 23 was connected to a vacuum. The vacuum was then actuated to apply a vacuum force of approximately 27-28 torr to the container. Next, a composition comprising about 100% MTMS was applied to the glass through inlet port 26. After 4 hours of incubation under vacuum pressure, the glasses were removed and allowed to dry at ambient temperature for about 12 hours. The glasses were then placed back in the container for an additional round of treatment.

The SEM image shown in FIG. 5 indicates that hardened glasses 12 formed first layer 13A and second layer 13B with the glass. Furthermore, the layers appeared to be more uniform than the layers formed at atmospheric pressure, as shown in FIG. 4. In addition, several cracks 50 appeared on the SEM image that spanned glass 12, first layer 13A and second layer 13B, indicating again that the compositions of the present invention in both layers may have penetrated below the surface of glass 12, possibly through various pores.

### Application of Adhesion Promoters

Adhesion promoters in the present invention may be applied to various glass laminate components. For instance, in one embodiment, adhesion promoters may be applied to a glass surface onto which a film or another glass is to be placed. In another embodiment, an adhesion promoter may be applied to a surface of a film that will adhere to a glass or another glass laminate component. In other embodiments, adhesion promoters may also be applied to both surfaces that are to adhere to one another.

Various methods may be used to apply adhesion promoters to the glass laminate components of the present invention. For instance, a preferred method of applying an adhesion promoter composition can be by atmospheric plasma deposition. Applicants have observed that atmospheric plasma deposition can provide glass laminate structures with enhanced impact resistance properties.

In other examples, adhesion promoter compositions may be applied onto a surface by spraying, desirably until a surface is saturated or substantially saturated with a composition. More desirably, a simple spray bottle may be filled with an adhesion promoter for such applications.

Adhesion promoters may alternatively be applied to a surface of a component of a glass laminate structure by other known manners. For instance, an adhesion promoter composition may be applied by pouring, wiping, and/or dipping. In a more specific embodiment, an adhesion promoter may be applied onto a peelable surface of a film. The peel may then be removed when one desires to adhere the film to another film or to a glass substrate.

In some embodiments, a glass laminate structure component may be pre-treated before the application of an adhesion promoter. For instance, a soap and water solution may be applied to a surface of a glass substrate before the application of an adhesion promoter. In another example, a film and/or glass substrate may be rinsed with acetone before the application of an adhesion promoter. In other embodiments, a film or glass substrate may be heated and/or cleaned by any known cleaning methods.

### Assembly

In the present invention, the assembly of glass laminate structures can generally entail the mounting of various components with one another in various arrangements until a desired glass laminate structure is obtained (such as one or more of the structures depicted in FIG. 1). Desirably, this can occur by mounting the components physically and without the use of any special equipment. More desirably, such mounting can occur after the application of an adhesion promoter to one or more of the component surfaces.

Before, during, and/or or after the completion of assembly, a glass laminate structure may be treated in other ways for enhanced adhesion and/or strength. Such treatments can include, without limitation, solvent treatment (e.g., by dipping, spraying, and/or wiping), heat treatment (e.g., oven treatment), autoclaving, and/or atmospheric plasma deposition. In one example, the final glass laminate structure may be autoclaved for about 120 minutes at about 275 F under about 140 pounds of pressure.

The aforementioned steps may be used to form numerous glass laminate structures that fall within the scope of the present invention. Applicants previously referred to FIG. 1 above to illustrate non-limiting examples of such structures.

The glass laminate structures of the present invention can have various advantages. For instance, glass-laminate structures of the present invention can be generally transparent, lightweight, compact, and have a higher impact resistance per cross-sectional area than conventionally-prepared structures. Furthermore, such glasses can substantially retain their transparency after an impact.

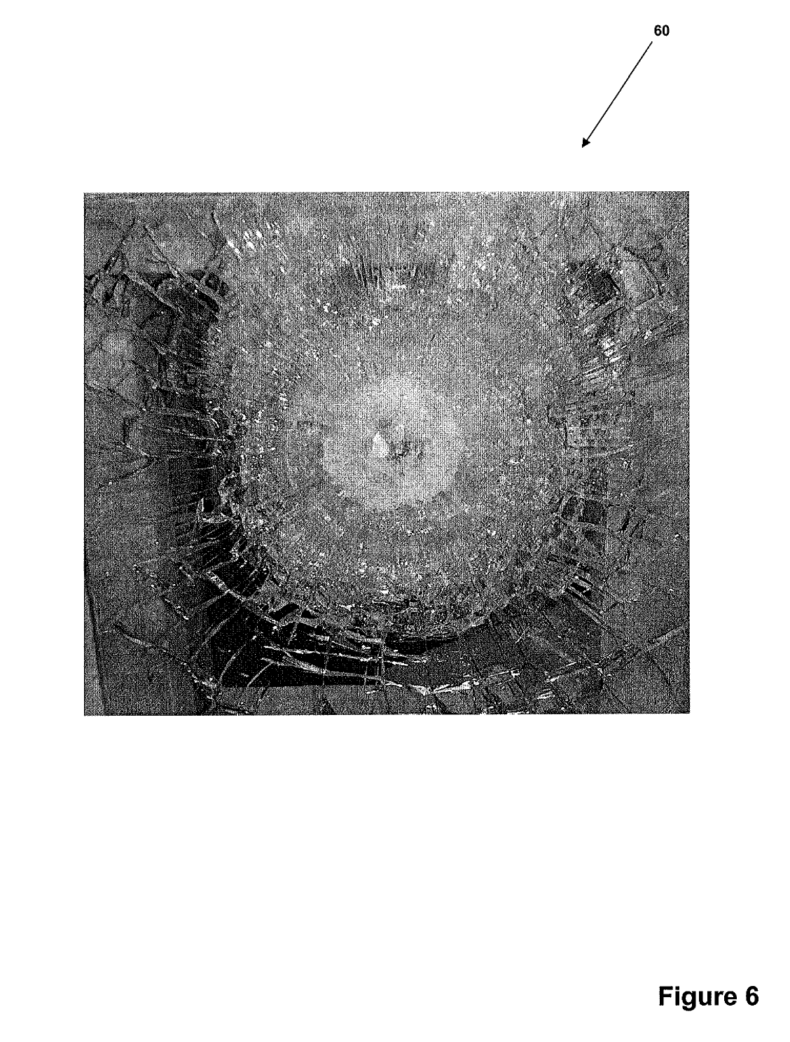

As shown in FIG. 6, a glass laminate structure 60 prepared in accordance with the present invention substantially retained its transparency after being struck by a bullet. Furthermore, as indicated by the image, the bullet failed to penetrate the glass laminate structure. In fact, ballistic tests on representative glass laminate structures of the present invention (e.g., 7.62 APM2 @ 2800 fps) have indicated that such structures actually destroyed and powdered the bullets. In contrast, many other glass laminate structures, which may be thicker and bulkier, may simply grind bullets to a halt due to their mass and thickness.

Advantageously, the glass laminate structures of the present invention can be made in a cost-effective manner, especially since many of its components can be affordable. For instance, many glass laminate structures of the present invention can have superior impact resistant properties without requiring the use of expensive glasses such as Alon® or sapphire specialty glasses. Nonetheless, such glasses can be used in various other embodiments of the present invention.

The glass-laminate structures of the present invention can be substantially resistant to impact from earthquakes, hurricanes and tornadoes. Furthermore, the glass-laminate structures of the present invention can be resistant to bullets and other objects. Accordingly, due to the aforementioned advantages, the glass laminate structures derived from the present invention can have various applications in numerous fields for various security and/or safety purposes. For instance, glass laminate structures of the present invention may be used for such purposes in various vehicles (e.g., without limitation, automobiles, trucks, humvees, buses, planes, tanks, trains, etc.), buildings, windshields, sun-glasses, optical glasses, watches, military hardware, medical devices, and other objects.

The glass-laminate structures derived from the present invention can also have various military-related applications. For instance, glass laminate structures of the present invention can be used in military vehicles, such as humvees, to resist impact from single or multiple rounds of bullets, IED's, grenades, rocks, and other objects.

The glass laminate structures of the present invention are particularly advantageous for such military applications due to their ability to substantially retain their transparency after an impact. In contrast, many glass laminate structures in use today may lose their transparency after an impact, even by a low-threat object, such as a rock.

From the foregoing description, one skilled in the art can easily ascertain the essential characteristics of this invention, and without departing from the spirit and scope thereof, can make various changes and modifications of the invention to adapt it to various usages and conditions. The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes to the claims that come within the meaning and range of equivalency of the claims are to be embraced within their scope. Further, all published documents, patents, and applications mentioned herein are hereby incorporated by reference, as if presented in their entirety.

1. A glass laminate structure comprising:
a. a first glass; and
b. an adhesion promoter, wherein said adhesion promoter comprises one or more silane-based compounds.

2. The glass laminate structure of claim 1, further comprising a first film.

3. The glass laminate structure of claim 2, wherein said adhesion promoter is between said first film and said glass.

4. The glass laminate structure of claim 2 or 3, wherein said first film is a thermoplastic polyurethane film.

5. The glass laminate structure of any of claims 1-4, wherein said adhesion promoter comprises about 60% by weight aminoethylaminopropyltrimethoxysilane, about 15% to about 40% by weight methoxysilane, about 1% by weight methanol, about 1% by weight ethylenediamine, and about 0.01% by weight titanate.

6. The glass laminate structure of any of claims 1-5, wherein said adhesion promoter comprises about 60% by weight glycidoxypropyl trimethoxysilane and about 0.01% by weight titinate.

7. The glass laminate structure of any of claims 1-6, wherein said adhesion promoter comprises about 60% by weight methyl (glycidoxypropyl) diethoxysilane and about 0.01% by weight titanate.

8. The glass laminate structure of any of claims 1-7, further comprising one or more thermoset layers.

9. The glass laminate structure of claim 8, wherein said one or more thermoset layers are selected from the group consisting of cyclobutanediol co-polymers, polyurethanes, polyesters, and polyimides.

10. The glass laminate structure of any of claims 1-9, further comprising one or more covers.

11. The glass laminate structure of claim 10, wherein said one or more covers are selected from the group consisting of polyethylenes, polycarbonates, polymethyl methacrylates, and polypropylenes.

12. The glass laminate structure of any of claims 2-11, further comprising one or more additional films.

13. The glass laminate structure of claim 12, wherein said one or more additional films are thermoplastic polyurethane films.

14. The glass laminate structure of any of claims 1-13, further comprising one or more additional glasses.

15. A method of forming a glass laminate structure comprising:
a. providing a first glass;
b. applying an adhesion promoter to a surface of said glass, wherein said adhesion promoter comprises one or more silane-based compounds;
c. placing a film on said surface of said glass.

16. The method of claim 15, further comprising placing one or more thermoset layers on said glass laminate structure.

17. The method of claim 15 or 16, further comprising placing one or more covers on said glass laminate structure.

18. The method of any of claims 15-17, further comprising placing one or more additional films on said glass laminate structure.

19. The method of any of claims 15-18, further comprising placing one or more additional glasses on said glass laminate structure.

20. A method of forming a glass laminate structure comprising:
a. providing a first glass;
b. applying an adhesive to a surface of a film; and
c. placing said film on a surface of said glass.

21. The method of claim 20, further comprising placing one or more thermoset layers on said glass laminate structure.

22. The method of claim 20 or 21, further comprising placing one or more covers on said glass laminate structure.

23. The method of any of claims 20-22, further comprising placing one or more additional films on said glass laminate structure.

24. The method of any of claims 20-23, further comprising placing one or more additional glasses on said glass laminate structure.

25. A glass laminate structure comprising a hardened glass, wherein said hardened glass comprises at least one layer of a coating composition comprising one or more silane-based compounds, and wherein the improvement of said glass laminate structure comprises an adhesion promoter that comprises one or more silane-based compounds.

26. The glass laminate structure of claim 25, further comprising a film.

27. The glass laminate structure of claim 26, wherein said film is a thermoplastic polyurethane film.

28. The glass laminate structure of claim 26 or 27, wherein said adhesion promoter is between said film and said glass.

29. The glass laminate structure of any of claims 25-28, wherein said adhesion promoter comprises about 60% by weight aminoethylaminopropyltrimethoxysilane, about 15% to about 40% by weight methoxysilane, about 1% by weight methanol, about 1% by weight ethylenediamine, and about 0.01% by weight titanate.

30. The glass laminate structure of any of claims 25-29, wherein said adhesion promoter comprises about 60% by weight glycidoxypropyl trimethoxysilane and about 0.01% by weight titinate.

31. The glass laminate structure of any of claims 25-30, wherein said adhesion promoter comprises about 60% by weight methyl (glycidoxypropyl) diethoxysilane and about 0.01% by weight titanate.

32. The glass laminate structure of any of claims 25-31, further comprising one or more thermoset layers.

33. The glass laminate structure of claim 32, wherein said one or more thermoset layers are selected from the group consisting of cyclobutanediol co-polymers, polyurethanes, polyesters, and polyimides.

34. The glass laminate structure of any of claims 25-33, further comprising one or more covers.

35. The glass laminate structure of claim 34, wherein said one or more covers are selected from the group consisting of polyethylenes, polycarbonates, polymethyl methacrylates, and polypropylenes.

36. The glass laminate structure of any of claims 26-35, further comprising one or more additional films.

37. The glass laminate structure of claim 36, wherein said one or more additional films are thermoplastic polyurethane films.

38. The glass laminate structure of any of claims 25-37, further comprising one or more additional glasses.

39. A vehicle with a glass laminate structure as described in any one of claim 1-14 or 25-38.

40. The vehicle of claim 39, wherein said vehicle is a humvee.

41. A bullet resistant windshield, wherein said windshield comprises the glass laminate structure of any one of claim 1-14 or 25-38.

42. A humvee with a bullet resistant windshield, wherein said windshield comprises the glass laminate structure of claim 1.
